(19) United States
(12) Patent Application Publication
(10) Pub. No.: US 2025/0027545 A1
(43) Pub. Date: Jan. 23, 2025

(54) ELECTROMAGNETIC SPRING PRESSURE BRAKE AND METHOD FOR PRODUCING SAME

(71) Applicant: CHR. MAYR GMBH + Co. KG, Mauerstetten (DE)

(72) Inventor: Martin HECHT, Kaufbeuren (DE)

(73) Assignee: CHR. MAYR GMBH + Co. KG, Mauerstetten (DE)

(21) Appl. No.: 18/245,650

(22) PCT Filed: Oct. 1, 2021
(86) PCT No.: PCT/EP2021/077143

§ 371 Date: Mar. 16, 2023

(30) Foreign Application Priority Data
Oct. 5, 2020 (DE) 10 2020 006 060.9

(51) Int. Cl. F16D 59/02

(52) U.S. Cl. CPC F16D 59/02

(57) ABSTRACT

The invention relates to an electromagnetic spring pressure brake (BR) which is inexpensive to produce and has an optimized power density and a long service life. This is achieved in that a coil support (1) and a flange plate (9) are connected together by means of narrow spacing strips (2) with a short radial extension, wherein the spacing strips (2) likewise take on the rotationally fixed and axially movable guidance of the armature disc (4). The invention additionally relates to a production method in which a connection is produced between the coil support (1), the spacing strips (2), and the flange plate (9) such that the smallest possible air gap (L) is produced between the coil 10 support (1) and the armature disc (4) when the spring pressure brake (BR) is closed in a reliable manner with respect to the process.

The present invention relates to an electromagnetic brake, in particular an electromagnetic spring-applied brake, preferably in a round design, consisting of, inter alia, a coil carrier having at least one force-exerting element, for example at least one compression spring, at least one solenoid, at least one armature disc, at least one brake rotor, which in a preferred embodiment is provided with friction linings on both planar faces, and a counter friction face, and to a method for producing said electromagnetic spring-applied brake, which is usually referred to below only as spring-applied brake.

The spring-applied brake according to the invention has a design which is optimised in terms of performance and service life, and is provided using a specific, cost-effective production method, by means of which the energy density of the spring-applied brake is increased further.

Electromagnetic spring-applied brakes in which the coil carrier is screw-fastened via spacer bushings to a counter friction face in the form of a flange plate are known from the prior art. Such a spring-applied brake is shown in FIG. 1. The spacer bushings are used for rotational fixing of the axially movable armature disc, as well as for connecting the coil carrier to the flange plate, and the at least one brake rotor is positioned radially inside the spacer bushings, as a result of which the outer diameter and thus the effective friction radius of the brake rotor is limited. The possible wear reserve of the friction linings, which depends on the structurally possible friction lining volume, is also limited thereby, which has a negative effect on the service life of the spring-applied brake.

In such designs, the so-called air gap of the spring-applied brake, which results between the coil carrier and the armature disc when the brake is closed, is defined by the dimensions of the components and as a result is subject to correspondingly sized tolerances arising from the sum of the tolerances of multiple components. As a result, in order to ensure a defined minimum air gap, an air gap with a large nominal size must be provided, which limits the force of the magnetic circuit of the electromagnet, said magnetic circuit consisting of the armature disc and coil carrier. The possible forces of the compression springs used and consequently the brake torque which can be generated by the spring-applied brake are thus also limited. With a given installation space for a spring-applied brake, the structure of which corresponds to the described prior art, the achievable brake torque thereof and the wear reserve thus cannot be increased further.

Measures for increasing the possible friction radius of the brake rotor are known from the prior art and can be found for example in WO2019007931A1. Said document proposes using, instead of separate spacer bushings, spacer elements which are formed integrally on the coil carrier and are also used for rotational fixing of the armature discs, and the through-holes of which for the fastening screws are open radially inwards towards the coil space for the solenoid. The friction radius of the brake rotor can be slightly increased thereby, as a result of which the achievable torque and the service life of the spring-applied brake, which depends on the friction lining volume, are also increased slightly. However, the influence of the component tolerances remains, and a large air gap must be provided along with all the associated disadvantages.

To increase the energy density further, DE102016103176A1 proposes a specific design and a production method for an electromagnetic spring-applied brake, preferably a round electromagnetic spring-applied brake. Thanks to the design, the friction radius of the brake rotor can be increased further, and the proposed method for the connection between the coil carrier and the flange plate via a preferably tubular connection element allows an optimised, small air gap to be achieved. However, in the spring-applied brake described, the connection of the coil carrier and the armature is functionally separate from the rotational fixing of the armature disc. For the rotational fixing of the armature disc, separate elements in the form of cylindrical bolts are provided, which are introduced into bores in the coil carrier. As a result, the manufacturing outlay is increased, and the pole surface of the coil carrier available for mounting spring elements and/or for increasing the force of the electromagnet is reduced. The achievable energy density is thus also limited in this spring-applied brake.

The object of the present invention is therefore to provide a preferably round electromagnetic spring-applied brake which is inexpensive to produce and has optimised energy density and a long service life and in which the friction radius of the at least one brake rotor reaches a maximum by means of design measures, in which the pole surface of the electromagnet formed from the coil carrier and the solenoid is free of additional guide elements for the armature disc, and in which existing component tolerances are eliminated by a specific production method, as a result of which a precise, very small air gap can be achieved between the electromagnet and the armature disc. In return, thickness tolerances on components such as the armature disc or the brake rotor can be widened, which allows further cost reductions. This object is achieved with the features of the independent claims of the invention.

In the spring-applied brake according to the invention, it is proposed to replace the spacer bushings with spacer strips which have a small radial extent and are produced integrally with the coil carrier or alternatively can be permanently connected to the coil carrier, for example by welding, adhesive bonding, screw fastening, riveting, crimping or a comparable connection method. The spacer strips, which have a rectangular or approximately rectangular cross-section at least in a portion of their length, provide the function of guiding the armature disc, which is rotationally fixed and movable in the axial direction as a result.

To fasten the spring-applied brake to the periphery, for example a machine wall, the coil carrier has corresponding screw-on threads or comparable connection possibilities. Alternatively, the flange plate can also be provided with corresponding connection possibilities, such as internal threads or threaded bolts, on the side opposite the coil carrier. The brake rotor is situated radially inside the at least three spacer strips between the armature disc and the flange plate and can thus have a large friction radius, which contributes to the high energy density and the large wear reserve of the spring-applied brake.

It is possible for the spring-applied brake according to the invention to be equipped with only one brake rotor, as a result of which it has a coil carrier, an armature disc, a brake rotor equipped with friction linings on both sides, and a flange plate, in the stated order of the components.

To multiply the achievable torques, the spring-applied brake can also be equipped with multiple brake rotors; for example, a double rotor brake has, in the stated order of the components, a coil carrier, an armature disc, a first brake rotor, an intermediate plate which is rotationally fixed and axially movable owing to the spacer strips, a second brake rotor, and finally a flange plate.

To increase the energy density further, the invention proposes using a specific production method during assembly of the spring-applied brake, by means of which method the manufacturing tolerances of the components leading to variations in the air gap are eliminated. To this end, the spacer strips and the flange plate are coordinated with one another such that the flange plate is situated with its outer circumference or with its flange plate grooves radially inside the centring region of the spacer strips and has a corresponding clearance for movement in the axial direction.

In the production method, it is provided to place the coil carrier equipped with compression springs with the planar face opposite the spacer strips onto a device plate and to insert the components armature disc, brake rotor and flange plate, in the stated order, into the space present radially between the spacer strips. Then, the flange plate is pressed using one or more press stamps in the direction of a first stroke movement against the coil carrier until all the stated components lie directly one on top of the other. Then, the one or more press stamps are moved in a displacement-controlled manner in the direction of a second stroke movement by a distance corresponding to the desired air gap of the spring-applied brake. Finally, a permanent connection is produced between the ends of the spacer strips facing the flange plate and the flange plate, for example by means of a welding, soldering or adhesive bonding method, preferably a laser welding method. In this case, the welding laser can be guided along the desired seam profile by means of a robot. Alternatively, the spring-applied brake with the region to be connected can be guided, on a device plate rotating about the rotational axis, along a welding laser. The spring-applied brake with the air gap thus produced can then be removed from the device plate and delivered to the customer as a unit ready for installation.

If the described production method is carried out with multiple press stamps distributed around the circumference of the spring-applied brake, each of which executes a displacement-controlled movement by itself, different installation height tolerances, distributed around the circumference, of the coil carrier and/or the armature disc and/or the flange plate can advantageously be compensated.

In an alternative production method, which can be carried out with only one or else with multiple press stamps, the coil carrier equipped with compression springs is first placed onto the device plate. Then, at least two spacer films, distributed around the circumference, are applied to the pole surface of the coil carrier, and then the armature disc, the brake rotor and the flange plate are positioned in the stated order. The thickness of the spacer films used in this case corresponds to the desired later air gap of the spring-applied brake. Then, the at least one press stamp presses the flange plate in the direction of the first stroke movement until all the stated parts including the spacer films lie directly one on top of the other. In this position, a permanent connection between the ends of the spacer strips and the outer circumference of the flange plate is produced, preferably by a laser welding method. The spacer films are then pulled off in the radial direction out of the gap between the coil carrier and the armature disc, as a result of which the desired air gap on the spring-applied brake is produced. After the press stamp has been retracted into its starting position, the spring-applied brake is then ready for delivery as a unit ready for installation.

Thanks to the described structure and the production method, a cost-effective electromagnetic spring-applied brake having optimised energy density and a long service life can be provided, in which the friction radius of the brake rotor reaches a maximum by means of design measures, in which the pole surface of the coil carrier allows the highest possible amount of magnetic and spring force with only a few interruptions, and in which component tolerances are eliminated by a specific production method, as a result of which a precise, very small air gap can be achieved between the coil carrier and the armature disc.

Further advantageous details of the invention can be found in the claims and in the description of the drawings mentioned below.

### DESCRIPTION OF THE FIGURES

FIG. 1 shows a longitudinal section through an electromagnetic spring-applied brake according to the prior art and a perspective view of same with a detail A.

FIG. 2 shows a longitudinal section through a first embodiment of a spring-applied brake according to the invention and a perspective view of same with a detail B.

FIG. 3 shows an exploded diagram of the first embodiment of a spring-applied brake according to the invention from FIG. 2 and a detail C.

FIG. 4 shows an exploded diagram of a second embodiment of a spring-applied brake according to the invention and a detail D of same.

FIG. 5 shows an exploded diagram of a third embodiment of a spring-applied brake according to the invention and a detail E of same.

FIG. 6 shows a longitudinal section through a fourth embodiment of a spring-applied brake according to the invention and a perspective view of same with a detail F.

FIG. 7 shows a longitudinal section through the first embodiment of a spring-applied brake according to the invention from FIG. 2 in a first adjusting device and a perspective view of same.

FIG. 8 shows a longitudinal section through the third embodiment of a spring-applied brake according to the invention from FIG. 5 in a second adjusting device and a perspective view of same.

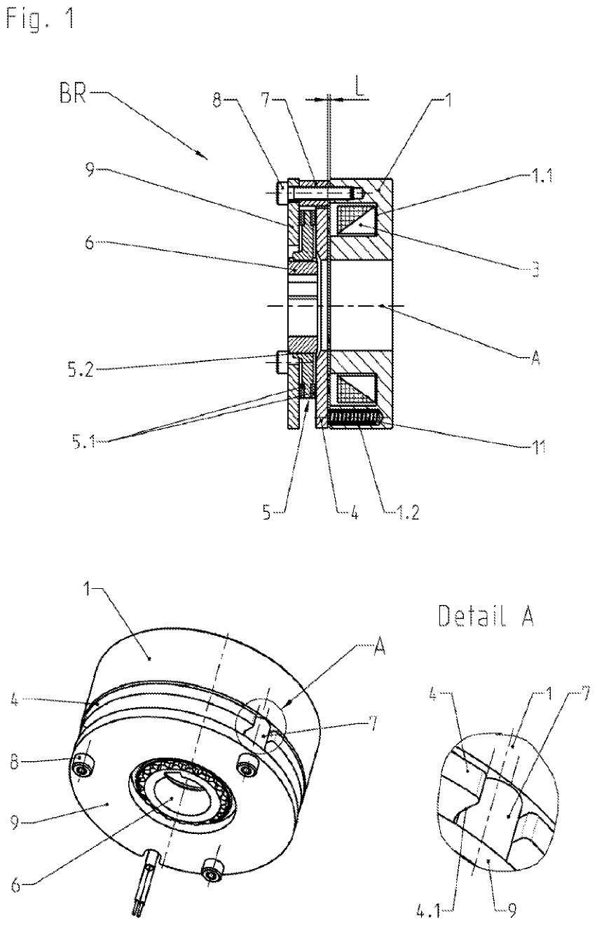

As shown in FIG. 1, in the electromagnetically ventilated spring-applied brake (BR) according to the prior art, a coil carrier (1) is connected to a flange plate (9) via spacer bushings (7) and screws (8). An armature disc (4) and a brake rotor (5) equipped on both sides with friction linings (5.1) are arranged between the coil carrier (1) and the flange plate (9), wherein the brake rotor (5) is in form-fitting engagement via a rotor toothing (5.2) with a toothed hub (6), which is in turn connected to a shaft (not shown), for example of a motor.

As can be seen from detail A, the armature disc (4) is guided rotationally fixedly and axially movably on the spacer bushings (7) via armature driver grooves (4.1) and, when the solenoid (3) is not energised, is pressed against the brake rotor (5) by means of compression springs (11), which are situated in spring bores (1.2) in the coil carrier (1). As a result, the brake rotor (5) is clamped between the armature disc (4) and the flange plate (9) and prevents the shaft (not shown) from rotating about the rotational axis (A) via the toothed hub (6). By energising the solenoid (3), which is embedded in a coil space (1.1) of the coil carrier (1), the armature disc (4) is attracted by the coil carrier (1) counter to the force of the compression springs (11) and releases the brake rotor (5), which can now rotate freely about the rotational axis (A) together with the toothed hub (6) and the shaft.

It can clearly be seen that the outer diameter of the brake rotor (5) is limited by the dimensions of the spacer bushings (7) and that the size of the air gap (L), resulting when the spring-applied brake (BR) is closed, between the coil carrier (1) and the armature disc (4) depends on the thickness of the armature disc (4) and of the brake rotor (5) and on the axial extent of the spacer bushings (7) and the corresponding dimensional tolerances. Owing to the limited size of the brake rotor (5) and the necessary size of the air gap (L), the spring-applied brake (BR) according to the prior art has a limited energy density and a limited service life.

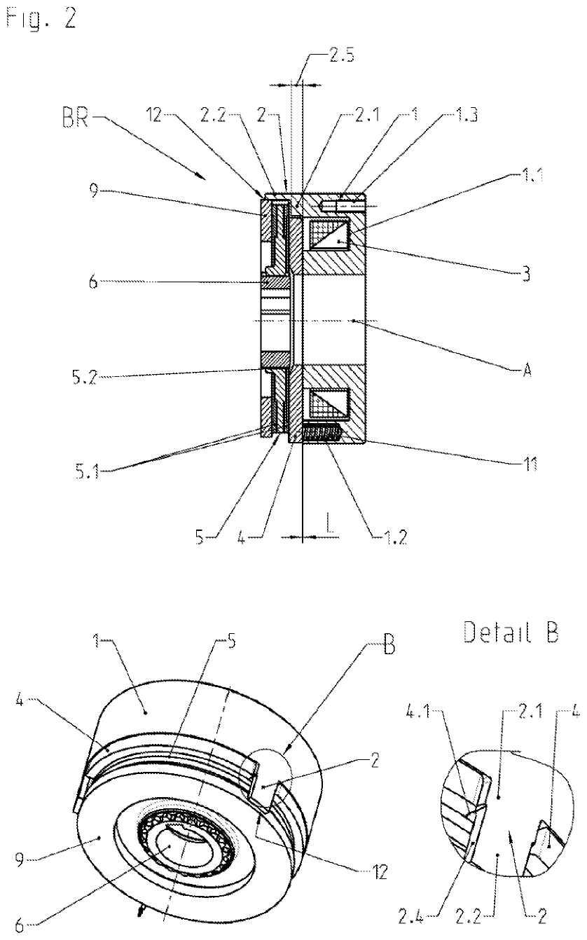

FIG. 2 shows a first embodiment of a spring-applied brake (BR) according to the invention, which corresponds largely to the prior art in terms of the spatial arrangement of the coil carrier (1), armature disc (4), brake rotor (5) and flange plate (9). Only the function of the spacer bushings (7) used in spring-applied brakes (BR) according to the prior art is provided by spacer strips (2), which form an integral geometry with the coil carrier (1). In this case, the spacer strips (2) firstly produce with their centring region (2.2) the connection between the coil carrier (1) and the counter friction face (9) via a connection point (12) and secondly provide with their guiding region (2.1) the function of the rotationally fixed and axially movable guidance of the armature disc (4) via armature driver grooves (4.1), as can be seen from detail B. Owing to the small radial extent of the centring region (2.2), the outer diameter of the brake rotor (5) can be much larger than the prior art, which, in conjunction with the small air gap (L), significantly increases the energy density and service life of the spring-applied brake (BR). The method for producing the spring-applied brake (BR), by means of which the small air gap (L) can be achieved, is described at another point.

Furthermore, the centring region (2.2) of the spacer strips (2) on both sides facing the armature driver grooves (4.1) is provided with free faces (2.4), and the axial guiding height (2.5) of the guiding region (2.1) is smaller than the axial thickness of the armature disc (4). As a result, even if there is wear in the guiding region (2.1), the armature disc (4) can be prevented from becoming embedded in the guiding region (2.1) and entering into a form-fitting connection with same. Consequently, it is ensured that the armature disc (4) transfers the full force of the compression springs (11) to the rotor (5) and the flange plate (9) during braking.

The spring-applied brake (BR) can be fastened to the periphery, for example to the housing interior of a servomotor, via screw-on threads (1.3) made in the rear of the coil carrier (1). It is likewise conceivable for the spring-applied brake (BR) to be fastened via threads, bolts or bores in the region of the flange plate (9).

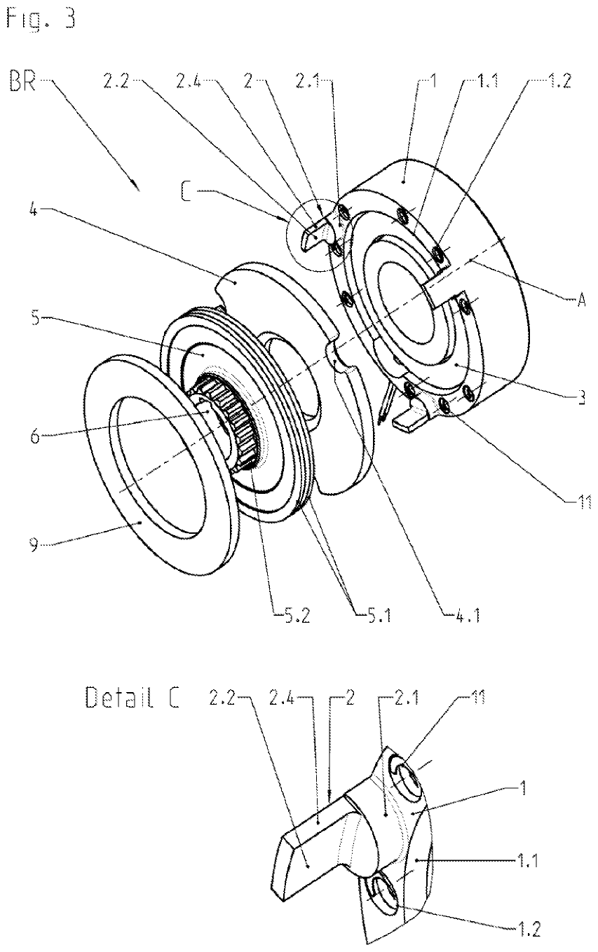

FIG. 3 and detail C show the spring-applied brake (BR) of FIG. 2 again, further details becoming clear from the perspective diagram with detail C. The spacer strips (2) formed integrally with the coil carrier (1) have guiding regions (2.1) for the rotationally fixed and axially movable guidance of the armature disc (4), and axially adjoining centring regions (2.2) for centring the flange plate (9). The guiding regions (2.1) are arcuate in order to form a large contact face opposite the armature driver grooves (4.1) to reduce wear and in order to reliably prevent tilting of the armature disc (4) during axial movement of same. This is important in particular because electromagnetic spring-applied brakes (BR) are usually safety-relevant components which operate according to the fail-safe principle and must apply their full braking effect in the de-energised state.

Moreover, in the proposed design of the guiding region (4.1), an armature disc (4) corresponding to the tried-and-tested design in a spring-applied brake (BR) according to the prior art as in FIG. 1 can be used.

The centring regions (2.2) are provided on both sides with laterally situated free faces (2.4) in order to ensure full mobility of the armature disc (4) during braking, even if there is wear on the guiding region (2.1).

Thanks to the arcuate inner contour of the centring region (2.2), a circular ring-shaped flange plate (9) can be used, which is inexpensive to produce and the outer contour of which fits exactly into the centring region (2.2).

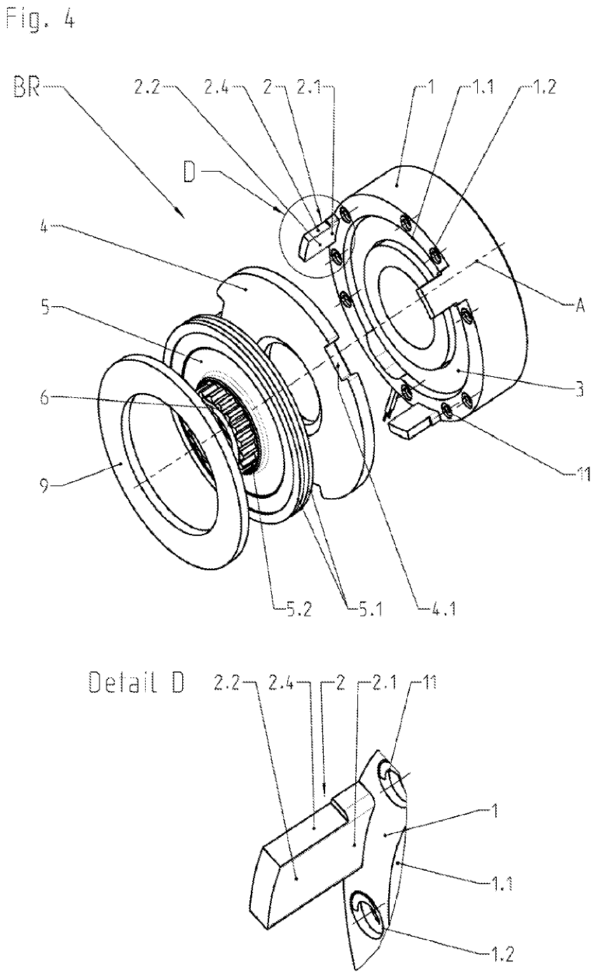

FIG. 4 and detail D show an alternative design of the spacer strips (2) formed integrally with the coil carrier (1). The guiding region (2.1) for rotationally fixed, axially movable guidance of the armature disc (4) and the centring region (2.2) for receiving the flange plate (9) in this case have, over the length of the spacer strip (2), a cross-section which is the same in the radial direction and is very inexpensive to produce, and the pole surface of the coil carrier (1) can be further enlarged thereby.

The spacer strips (2) have a smaller extent in the circumferential direction only in the centring region (2.2) owing to the free faces (2.4), in order to ensure full mobility of the armature disc (4) during braking.

In the present example, the armature disc (4) has corresponding armature driver grooves (4.1) with a rectangular cross-section.

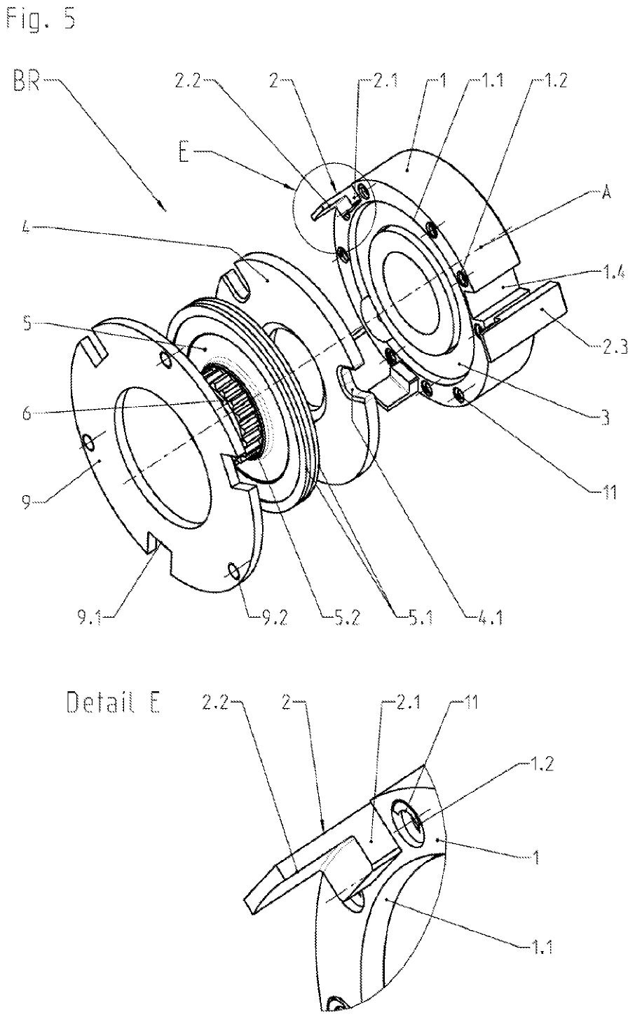

FIG. 5 with detail E shows a further embodiment of the spring-applied brake (BR) according to the invention, in which the spacer strips (2) and the coil carrier (1) are not formed integrally. In this case, the spacer strips (2) each consist of a centring region (2.2), a guiding region (2.1) and a strip shank (2.3), which is inserted into a complementary axially extending receiving groove (1.4) of the coil carrier (1) and permanently connected there to the coil carrier (1), for example by welding, adhesive bonding, screw fastening, riveting, crimping or a comparable alternative connection method. In this example, the strip shank (2.3) has a larger radial extent than the centring region (2.2) and protrudes in the axial direction beyond the pole surface of the coil carrier, so that the strip shank (2.3) in this case also provides the function of the guiding region (2.1). The armature driver grooves (4.1) of the armature disc (4) are designed with a correspondingly complementary geometry.

Alternatively, it is also conceivable to design the spacer strips (2) with a constant cross-section along their entire length or to provide a smaller radial extent in the strip shank (2.3) than in the guiding region (2.1) and centring region (2.2).

Furthermore, it is also possible to provide the centring region (2.2) of the spacer strips (2) with suitable free faces (2.4), as in FIG. 2 to FIG. 4.

To fasten the spring-applied brake (BR) shown to the periphery, the outer diameter of the flange plate (9) protrudes beyond the coil carrier (1), so that the spring-applied brake (BR) can also take place through fastening bores (9.2) from the side of the coil carrier (1), for example. It is likewise conceivable for the spring-applied brake (BR) also to be fastened via screw-on threads (1.3) or corresponding bores or bolts in the region of the coil carrier (1).

In the present example according to FIG. 5, the connection between the flange plate (9) and the spacer strips (2) is produced between the respective groove bottom of the flange plate grooves (9.1) and the centring regions (2.2) of the spacer strips (2).

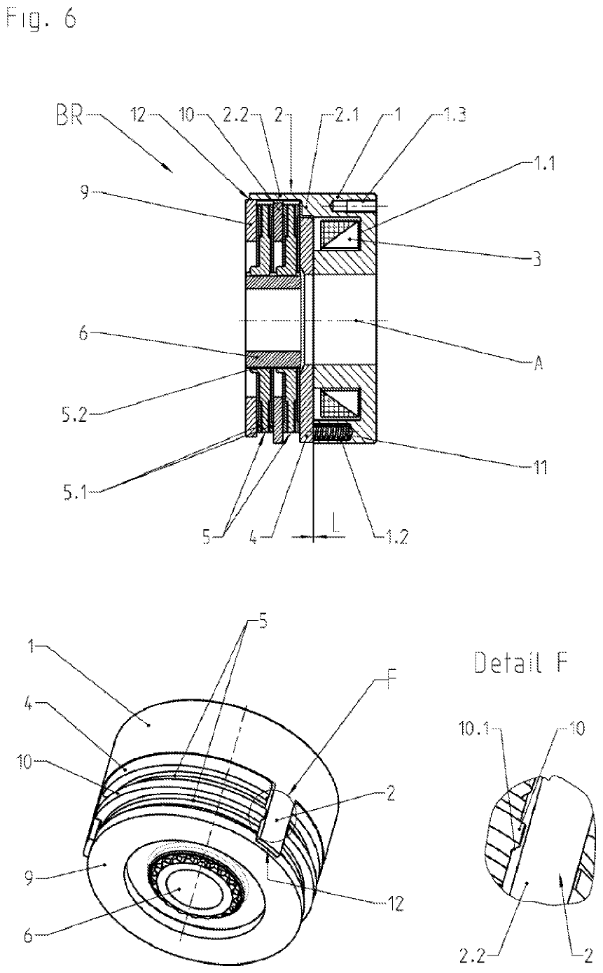

The longitudinal section in FIG. 6 with a perspective diagram and a detail F shows a spring-applied brake (BR) in a double rotor design, as a result of which the achievable brake torque can likewise be doubled by doubling the number of friction faces. Alternatively, embodiments with three or more brake rotors (5) are also conceivable. In the spring-applied brake (BR) shown, the spacer strips (2) and the coil carrier (1) form an integral geometry, wherein the centring regions (2.2) of the spacer strips (2) have a larger axial extent parallel to the rotational axis (A) for receiving the additional components. Accordingly, the spring-applied brake (BR) consists of a coil carrier (1), an armature disc (4), a first brake rotor (5), an intermediate plate (10), a second brake rotor (5), and a terminating flange plate (9), wherein the components are arranged in the stated order. The armature disc (4) is mounted rotationally fixedly and axially movably on the guiding regions (2.1) of the spacer strips (2), wherein the guiding regions (2.1) can be designed with a small or large radial extent and can be angular or designed with corresponding rounded portions. The intermediate plate (10) is situated in the centring region (2.2) of the spacer strips (2) and is mounted there rotationally fixedly and axially movably on the centring region (2.2) by means of its intermediate plate driver grooves (10.1).

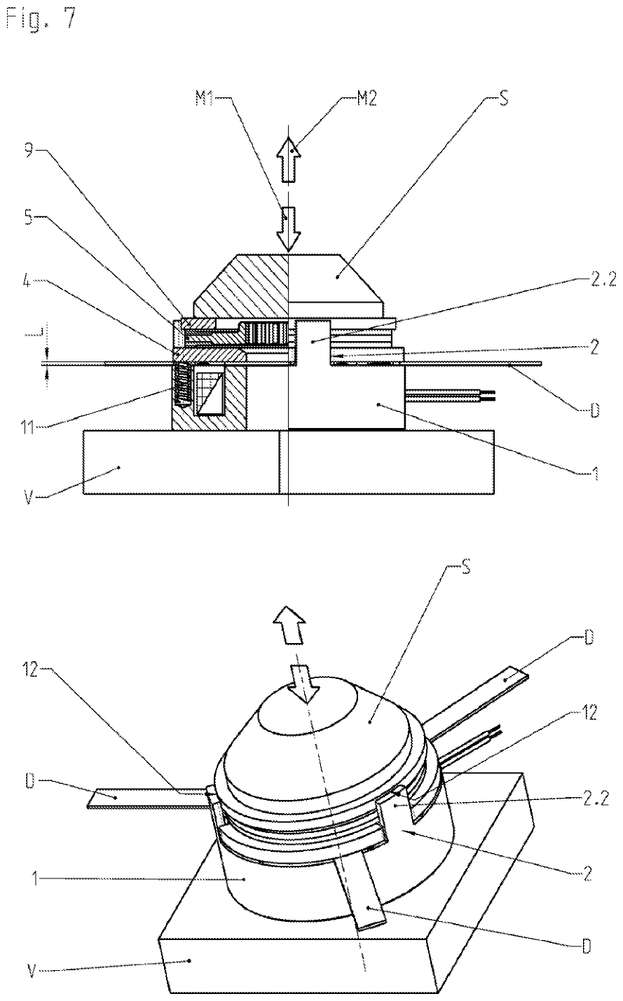

Using the half section and the perspective diagram of FIG. 7, a first production method is explained, by means of which an increase in the possible brake torque is achieved with a reduction in the air gap (L). The method can be applied to all the spring-applied brakes (BR) described previously using FIG. 2 to FIG. 6, but also to spring-applied brakes (BR) with a non-round, for example rectangular or polygonal, outer contour, in which the functional parts are arranged in a comparable manner. In the production method described using the example of FIG. 7, which can be carried out with only one or else with multiple press stamps(S), the coil carrier (1) equipped with compression springs (11) is first placed onto the device plate (V). Then, at least two spacer films (D), preferably three spacer films (D), distributed around the circumference, are applied to the pole surface of the coil carrier (1), and then the armature disc (4), the brake rotor (5) and the flange plate (9) are positioned in the stated order. Alternatively, the spacer films (D) can also be positioned between the armature disc (4) and the brake rotor (5) or between the brake rotor (5) and the flange plate (9). The thickness of the spacer films (D) used in this case corresponds to the desired later air gap (L) of the spring-applied brake (BR). Then, the at least one press stamp(S) presses the flange plate (9) in the direction of a first stroke movement (M1) until all the stated parts including the spacer films (D) lie directly one on top of the other. In this position, a permanent connection between the ends of the spacer strips (2) and the outer circumference of the flange plate (9) is produced at the connection points (12), preferably by a laser welding method. The spacer films (D) are then pulled off in the radial direction out of the gap between the coil carrier (1) and the armature disc (4), as a result of which the desired air gap (L) on the spring-applied brake (BR) is produced.

The press stamp(S) is then retracted in the direction of the second stroke movement (M2), the spring-applied brake (BR) is removed and is ready for delivery as a unit ready for installation. It is self-evident that the procedure described above is not a limitation in terms of the spatial orientation of the described components. The device plate (V) can be in any spatial position, and the position of the parts of the spring-applied brake (BR) and of the press stamp(S) is defined by the position of the device plate (V). Preferably, the device plate (V) is spatially at the bottom with all the parts of the spring-applied brake (BR) and the press stamp(S) spatially thereabove.

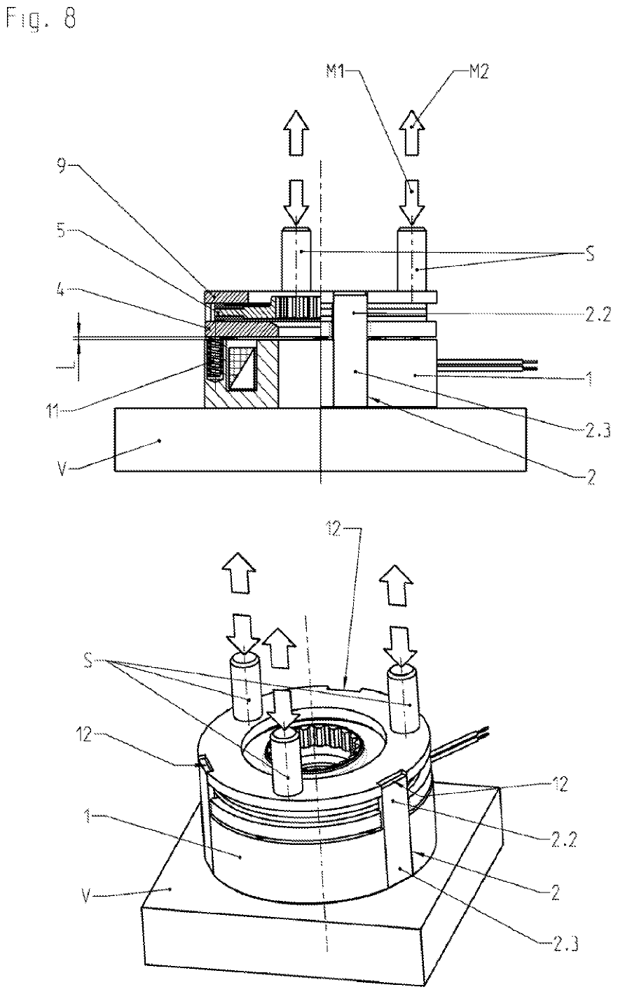

An alternative production method is described using the half section and the perspective view in FIG. 8. In the alternative production method, it is provided to place the coil carrier (1) equipped with compression springs (11) with the planar face opposite the spacer strips (2) onto a device plate (V) and to insert the components armature disc (4), brake rotor (5) and flange plate (9), in the stated order, into the space present radially between the spacer strips (2). Then, the flange plate (9) is pressed in the direction of a first stroke movement (M1) against the coil carrier (1) using a press stamp lying concentrically with the rotational axis or using multiple press stamps(S) lying on a part-circle concentric with the rotational axis, until all the stated components lie directly one on top of the other. Then, the single or multiple press stamps(S) are moved in a displacement-controlled manner in the direction of a second stroke movement (M2) by the desired air gap (L) of the spring-applied brake (BR).

Finally, a permanent connection is produced at the connection point (12) between the ends of the spacer strips (2) facing the flange plate (9) and the flange plate (9), for example by means of a welding, soldering or adhesive bonding method, preferably a laser welding method. In this case, the welding laser can be guided along the desired seam profile by means of a robot.

Alternatively, the spring-applied brake (BR) with the region to be connected can also be guided, on a device plate (V) rotating about the rotational axis (A), along a welding laser.

If the described production method is carried out with multiple press stamps(S) distributed around the circumference of the spring-applied brake (BR), each of which executes a displacement-controlled movement by itself, different installation height tolerances, distributed around the circumference, of the coil carrier (1) and/or the armature disc (4) and/or the brake rotor (5) can advantageously be compensated.

If one of the production methods according to FIG. 7 or FIG. 8 is applied to a spring-applied brake (BR) having two brake rotors (5) as shown in FIG. 6 or in a spring-applied brake (BR) having more than two brake rotors (5), only at least one additional brake rotor (5) and at least one intermediate plate (9) have to be inserted into the space between the guiding regions (2.2) of the spacer strips (2) in comparison with the spring-applied brake (BR) having one brake rotor (5). The other method steps correspond to the procedure described in connection with FIG. 7 and FIG. 8.

In the embodiment of the spring-applied brake (BR) according to FIG. 5, in which the coil carrier (1) and the spacer strips (2) are formed as separate components, an alternative variant of the production method is conceivable, which is described below. In a first step, the still loose spacer strips (2) are connected to the flange plate (9) at the intended connection points (12) in advance, and the resulting assembly is fixed to the coil carrier (1) later.

In a production method analogous to the method shown in FIG. 7, in a second step, the assembly consisting of the flange plate (9) and the spacer strips (2) is first placed onto the device plate (V), and then the brake rotor (5), the armature disc (4), the spacer films (D) and the coil carrier (1) with the compression springs (11) are attached, wherein each strip shank (2.3) then engages in the associated receiving groove (1.4) in the coil carrier. Then, the coil carrier (1) is moved in the direction of a first stroke movement (M1) towards the flange plate by one or more press stamps(S) until all the components lie directly one on top of the other.

In this state, the spacer strips (2) are pressed radially into the receiving grooves (1.4) of the coil carrier (1) if required and then fastened to the coil carrier, for example by a welding, soldering or adhesive bonding method, preferably by a laser welding method. Then, the spacer films (D) are pulled off radially out of the spring-applied brake (BR), the at least one press stamp(S) is retracted into its starting position in the direction of the second stroke movement (M2), and the spring-applied brake (BR) can be removed as a finished unit.

In a production method analogous to the method shown in FIG. 8, in a second step, the assembly consisting of the flange plate (9) and the spacer strips (2) is first placed onto the device plate (V), and then the brake rotor (5), the armature disc (4) and the coil carrier (1) with the compression springs (11) are attached, wherein each strip shank (2.3) then engages in the associated receiving groove (1.4) in the coil carrier. Then, the coil carrier (1) is moved in the direction of a first stroke movement (M1) towards the flange plate by one or more press stamps(S) until all the components lie directly one on top of the other.

Then, the at least one press stamp(S) is retracted in a displacement-controlled manner in the direction of the second stroke movement (M2) by a distance corresponding to the desired air gap (L) on the spring-applied brake (BR). In this state, the spacer strips (2) are pressed radially into the receiving grooves (1.4) of the coil carrier (1) if required and then fastened to the coil carrier, for example by a welding, soldering or adhesive bonding method, preferably by a laser welding method. Finally, the at least one press stamp(S) is retracted into its starting position, and the spring-applied brake (BR) can be removed as a finished unit.

### LIST OF REFERENCE SIGNS

1 Coil carrier
1.1 Coil space
1.2 Spring bore
1.3 Screw-on thread
1.4 Receiving groove
2 Spacer strip
2.1 Guiding region
2.2 Centring region
2.3 Strip shank
2.4 Free face
2.5 Guide height
3 Solenoid
4 Armature disc
4.1 Armature driver groove
5 Brake rotor
5.1 Friction lining
5.2 Rotor toothing
6 Toothed hub
7 Spacer bushing
8 Screw
9 Flange plate
9.1 Flange plate groove
9.2 Fastening bore
10 Intermediate plate
10.1 Intermediate plate driver groove
11 Compression spring
12 Connection point
A Rotational axis
BR Spring-applied brake
D Spacer film
L Air gap
M1 First stroke movement
M2 Second stroke movement
S Press stamp
V Device plate

1. An electromagnetically released spring-applied brake (BR) having a rotational axis (A) for attachment to a machine wall or to a machine housing or similar,
wherein the spring-applied brake (BR) consists of a coil carrier (1), of at least one armature disc (4), at least one brake rotor (5) and a flange plate (9),
wherein the coil carrier (1) is equipped with one or more solenoids (3) and with one or more compression springs (11),
wherein the parts of the coil carrier (1) up to the flange plate (9) are arranged one behind the other in the stated order along the rotational axis (A),
wherein the coil carrier (1) has, in the region of its outer circumference and proceeding from the pole surface, at least three axially extending spacer strips (2), which are permanently connected to the coil carrier (1),
wherein each of the spacer strips (2) ensures, with a guiding region (2.1), via a corresponding armature driver groove (4.1) of the at least one armature disc (4), a rotationally fixed and axially movable mounting of the at least one armature disc (4), wherein each of the spacer strips (2) has a centring region (2.2), which axially adjoins the guiding region (2.1) and is permanently connected to the flange plate (9) via a connection point (12),
wherein the brake rotor (5) is clamped between the at least one armature disc (4) and the flange plate (9) by the force of the at least one compression spring (11) to achieve a braking effect,
and wherein the at least one armature disc (4) is drawn towards the coil carrier (1) counter to the force of the at least one compression spring (11) by energising the at least one solenoid (3) to suspend the braking effect.

2. The spring-applied brake (BR) according to claim 1, characterised in that the coil carrier (1) is formed integrally with the spacer strips (2).

3. The spring-applied brake (BR) according to claim 1, characterised in that the spacer strips (2) have, over their axial extent, a uniform cross-section of the centring region (2.2) and the guiding region (2.1) with a space-optimised, small radial extent.

4. The spring-applied brake (BR) according to claim 1, characterised in that the spacer strips (2) have, over their axial extent, a differing cross-section of guiding region (2.1) and centring region (2.2), that the guiding region (2.1) has a larger radial extent than the centring region (2.2), and that the guiding region (2.1) has, in its region facing the armature driver groove (4.1), a rounded or angular geometry.

5. The spring-applied brake (BR) according to claim 1, characterised in that the spacer strips (2) have, over their axial extent, a cross-section which corresponds to the part of a cylinder lateral face with the rotational axis (A), at least on the inner side of the centring region (2.2).

6. The spring-applied brake (BR) according to claim 1, characterised in that the coil carrier (1) and the spacer strips (2) are designed as separate components.

7. The spring-applied brake (BR) according to claim 6, characterised in that the spacer strips (2) have a uniform cross-section over their axial extent in the region of the strip shank (2.3), centring region (2.2) and guiding region (2.1).

8. The spring-applied brake (BR) according to claim 6, characterised in that the spacer strips (2) have, over their axial extent, a cross-section with which the radial extent of the strip shank (2.3) is larger than the radial extent of the guiding region (2.1) and/or of the centring region (2.2).

9. The spring-applied brake (BR) according to claim 6, characterised in that the spacer strips (2) have, over their axial extent, a cross-section with which the radial extent of the strip shank (2.3) is smaller than the radial extent of the guiding region (2.1) and/or of the centring region (2.2).

10. The spring-applied brake (BR) according to claim 6, characterised in that the spacer strips (2) have a rectangular cross-section over their axial extent, and that the receiving grooves (1.4) of the coil carrier (1) have an approximately right angle between the groove bottom and the groove flanks.

11. The spring-applied brake (BR) according to claim 1, characterised in that the spacer strips (2) are preferably arranged on the coil carrier (1) at equal angular intervals from one another in relation to a rotational axis (A).

12. The spring-applied brake (BR) according to claim 1, characterised in that the flange plate (9) has the shape of a smooth circular ring.

13. The spring-applied brake (BR) according to claim 1, characterised in that the flange plate (9) has the shape of a circular ring, and that the contact regions of the flange plate (9) pointing radially towards the centring region (2.2) each form a flat geometry.

14. The spring-applied brake (BR) according to claim 1, characterised in that the centring regions (2.2) of the spacer strips (2) have laterally arranged, mutually opposing free faces (2.4), so that the centring regions (2.2) have a smaller width in the circumferential direction than the guiding regions (2.1).

15. A method for producing an electromagnetically released spring-applied brake (BR), wherein the spring-applied brake (BR) consists of a coil carrier (1), of at least one armature disc (4), at least one brake rotor (5) and a flange plate (9),
wherein the coil carrier (1) is equipped with one or more solenoids (3) and with one or more compression springs (11),
wherein the parts of the coil carrier (1) up to the flange plate (9) are arranged one behind the other in the stated order along the rotational axis (A),
wherein the coil carrier (1) has, in the region of its outer circumference and proceeding from the pole surface, at least three axially extending spacer strips (2), which ensure, via a guiding region (2.1), a rotationally fixed and axially movable mounting of the at least one armature disc (4) and which allow, via a centring region (2.2) and via a connection point (12), a permanent connection to the flange plate (9),
wherein the individual parts of the spring-applied brake (BR), from the coil carrier (1) to the flange plate (9), are inserted in the stated order into a device which consists of a device plate (V) and at least one press stamp(S),
wherein either the press stamp(S) presses all the parts of the spring-applied brake (BR) onto each other in direct contact against the device plate (V) and is then retracted in a displacement-controlled manner by the size of the desired air gap (L), and the spacer strips (2) are connected to the flange plate (9) or to the coil carrier (1) in this position,
or wherein the press stamp(S) presses all the parts of the spring-applied brake (BR) with spacer films (D) inserted therebetween onto each other in direct contact against the device plate (V), then the spacer strips (2) are connected to the flange plate (9) or to the coil carrier (1), and at the end the spacer films (D) are removed from the spring-applied brake (BR).

16. The production method according to claim 15, characterised in that before the start of the production method, the spacer strips (2) with the coil carrier (1) form a permanently connected, prefabricated unit, and that a connection between the spacer strips (2) and the flange plate (9) is produced in the device during the production method.

17. The production method according to claim 15, characterised in that before the start of the production method, the spacer strips (2) with the flange plate (9) form a permanently connected, prefabricated unit, and that a connection between the spacer strips (2) and the coil carrier (1) is produced in the device during the production method.

18. The production method according to claim 16, characterised in that the connection between the spacer strips (2) and the coil carrier (1) and/or between the spacer strips (2) and the flange plate (9) is produced by an adhesive bonding, soldering, screw-fastening or welding method.

19. The production method according to claim 18, characterised in that the connection between the spacer strips (2) and the coil carrier (1) and/or between the spacer strips (2) and the flange plate (9) is produced by a preferred laser welding method.

20. The spring-applied brake (BR) according to claim 1, characterised in that the spring-applied brake (BR) and in particular the coil carrier (1) have a round outer contour, preferably a circular outer contour.

21. The spring-applied brake (BR) according to claim 1, characterised in that the spring-applied brake (BR) and in particular the coil carrier (1) have a rectangular outer contour, preferably a square outer contour.

22. The spring-applied brake (BR) according to claim 1, characterised in that the spring-applied brake (BR) and in particular the coil carrier (1) have a multiangular or polygonal outer contour.

23. The spring-applied brake (BR) according to claim 2, characterised in that the spacer strips (2) have, over their axial extent, a uniform cross-section of the centring region (2.2) and the guiding region (2.1) with a space-optimised, small radial extent.

24. The spring-applied brake (BR) according to claim 2, characterised in that the spacer strips (2) have, over their axial extent, a differing cross-section of guiding region (2.1) and centring region (2.2), that the guiding region (2.1) has a larger radial extent than the centring region (2.2), and that the guiding region (2.1) has, in its region facing the armature driver groove (4.1), a rounded or angular geometry.

25. The spring-applied brake (BR) according to claim 2, characterised in that the spacer strips (2) have, over their axial extent, a cross-section which corresponds to the part of a cylinder lateral face with the rotational axis (A), at least on the inner side of the centring region (2.2).

26. The method of producing the spring-applied brake (BR) according to claim 15, characterised in that the spring-applied brake (BR) and in particular the coil carrier (1) have a round outer contour, preferably a circular outer contour.

27. The method of producing the spring-applied brake (BR) according to claim 15, characterised in that the spring-applied brake (BR) and in particular the coil carrier (1) have a rectangular outer contour, preferably a square outer contour.

28. The method of producing the spring-applied brake (BR) according to claim 15, characterised in that the spring-applied brake (BR) and in particular the coil carrier (1) have a multiangular or polygonal outer contour.
